(19) United States
(12) Patent Application Publication
(10) Pub. No.: US 2012/0130022 A1
(43) Pub. Date: May 24, 2012

(54) Method for Providing a Side-Chain Dendrimer Vesicle

(76) Inventors: Wen-Chiung Su, Taoyuan County (TW); Wei-Ho Ting, Taichung (TW); Mao-Syong Lin, Taichung (TW); Chia-Cheng Chang, Taichung (TW); Hsin-Cheng Chiu, Taichung (TW); Sheng-hong Dai, Taichung (TW); Ru-Jong Jeng, Taichung (TW)

(21) Appl. No.: 13/103,047

(22) Filed: May 7, 2011

(30) Foreign Application Priority Data
Nov. 19, 2010 (TW) 099139885

(51) Int. Cl. C08F 8/30

(52) U.S. Cl. 525/375

(57) ABSTRACT

A method for making a side-chain dendrimer vesicle includes the following steps. At first, there is provided a random copolymer with a narrow distribution of molecular weights by active polymerization and chemical modification. Then, chemical modification is executed to graft various generations of dendrimers to the random copolymer to provide a side-chain dendritic random copolymer with various generations. Two steps of emulsification are taken to induce macromolecular self-assembling of the side-chain dendritic random copolymer solution to form the macromolecular vesicle. The side-chain dendrimer includes C₁₀˜C₁₈ hydrophobic alkyl chains.

### BACKGROUND OF INVENTION

1. Field of Invention

The present invention relates to a method for providing a side-chain dendrimer vesicle and, more particularly, to a method including two steps of emulsification for causing macromolecular self-assembling of side-chain dendritic random copolymer solution for providing a macromolecular vesicle.

2. Related Prior Art

Macromolecular vesicles have been used to overcome problems related to the un-stability of liposome for some time. An approach to the problems is to use a lipid polymer to form a macromolecular vesicle. Therefore, synthetic molecule templates used for macromolecular vesicles are very important.

In 1990, Discher et al. (B. M. Discher, Y.-Y. Won, D. S. Ege, J. C.-M. Lee, F. S. Bates, D. E. Discher, D. A. Hammer, Science 1999, 284, 1143) disclosed the forming of a macromolecular vesicle via the self-assembling of macromolecules without using templates. The polymeric vesicles derive from diblock copolymer was called “Polymersomes” (polymer-based liposomes). Since then, macromolecular vesicles have gained a lot of attention for two major reasons. At first, macromolecular vesicles are an important issue of intra-molecular interactions and supra-molecular assembling structures. Secondly, the self-assembling structures are cell-mimetic, and exhibit the possibility of responding to other function groups. Moreover, the macromolecular vesicles exhibit excellent stability, tens or even hundreds of times higher than that of micro-molecular phosphatide (H. Ringsdorf, B. Schlarb, J. Venzmer, Angewandte Chemie International Edition 1988, 27, 113; W. Meier, Chemical Reviews 2000, 29, 295).

In solution, amphiphilic block copolymers self-assemble into various structures such as cylindrical, wedge-like, conical, rod-like and spherical structures have been widely reported. Self-assembly behaviors of macromolecular vesicle are influenced by their chemical structures and processing conditions. Diverse geometric shapes and structures are influenced and controlled by the weight percentages of their hydrophilic soft segments (F. Ahmed, D. E. Discher, Journal of Controlled Release 2004, 96, 37). To prepare the macromolecular vesicles, there are four major methods including direct solution (K. K. Jette, D. Law, E. A. Schmitt, G. S. Kwon, Pharmaceutical Research 2004, 21, 1184), dialysis (V. P. Torchilin, Journal of Controlled Release 2001, 73, 137), emulsification (F. Gao, Z.-G. Su, P. Wang, G.-H. Ma, Langmuir 2009, 25, 3832), and solution-injection (M. E. Yildiz, R. K. Prud'homme, I. Robb, D. H. Adamson, Polymers for Advanced Technologies 2007, 18, 427). A lot of efforts are made on the research of block copolymers that exhibit significant structures and narrow distribution of their molecular weights. It is however difficult to precisely synthesize these block copolymers. In comparison, random copolymers exhibit many chemical functionalities and can readily be obtained. Only a few efforts are however made on the self-assembling of the random copolymers in solution because the random copolymers exhibit unidentified structures and wide ranges of molecular weights.

Self-assembling of amphiphilic random copolymers in aqueous solution to form nanometer macromolecules and to release encapsulated content by external stimulation have therefore gained a lot of attention (F. Tian, Y. Yu, C. Wang, S. Yang, Macromolecules 2008, 41, 3385; H.-C. Chiu, Y.-W. Lin, Y.-F. Huang, C.-K. Chuang, C.-S. Chern, Angewandte Chemie International Edition 2008, 47, 1875). Hence, adopting a practicable method to prepare a side-chain dendrimer vesicle to avoid the problems encountered in the prior art is necessary.

The present invention is therefore intended to obviate or at least alleviate the problems encountered in the prior art.

### SUMMARY OF INVENTION

It is the primary objective of the present invention to provide a practical method for providing a macromolecular self-assembling of side-chain dendritic random copolymer vesicle by two step emulsification.

To achieve the foregoing objectives, the method includes the step of providing a random copolymer with a narrow distribution of molecular weights by active polymerization and chemical modification. Then, chemical modification is executed via grafting various generations of dendrimers to the random copolymer to provide a side-chain dendritic random copolymer with various generations. Two steps of emulsification are taken to cause macromolecular self-assembling of the side-chain dendritic random copolymer solution to form the macromolecular vesicle. The grafted side-chain dendrimer includes hydrophobic C₁₀˜C₁₈ alkyl chains.

Other objectives, advantages and features of the present invention will be apparent from the following description referring to the attached drawings.

### BRIEF DESCRIPTION OF DRAWINGS

The present invention will be described via detailed illustration of several embodiments referring to the drawings wherein:

FIG. 1 shows a chemical equation for synthesizing an IDD monomer according to the present invention;

FIG. 2 shows a process for synthesizing various generations of dendrimers according to the present invention;

FIG. 3 shows a process for synthesizing styrene according to the present invention;

FIG. 4 shows a process for synthesizing r-PS-PVBAm-[G-0.5]-C18 according to the present invention;

FIG. 5 shows a process for synthesizing r-PS-PVBAm-[G-1.5]-C18 according to the present invention;

FIG. 6 shows a process for synthesizing r-PS-PVBAm-[G-2.5]-C18 according to the present invention;

FIG. 7 is a microscopic photograph of a compound I-B according to the present invention; and

FIG. 8 is a microscopic photograph of a compound I-C according to the present invention.

### DETAILED DESCRIPTION OF EMBODIMENTS

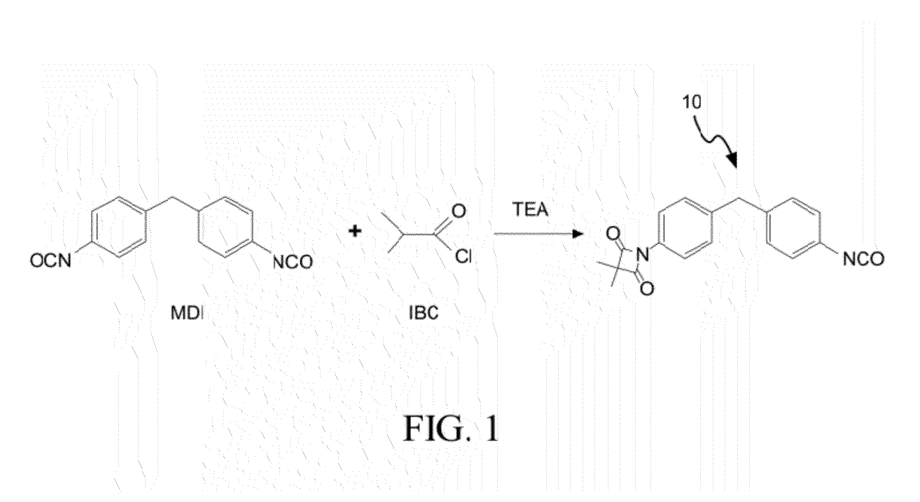

Referring to FIGS. 1 to 8, there is shown a method for providing a side-chain dendrimer vesicle according to the present invention. In the method, active polymerization and chemical modification are executed to provide a random copolymer that exhibits a narrow range of molecular weights. Then, chemical modification is conducted to graft various generations of dendrimers to the backbone of the random copolymer, thus forming a precise side-chain dendritic random copolymer with various generations. Two successive steps of emulsification are taken to induce macromolecular self-assembling of the side-chain dendritic random copolymer solution to form the macromolecular vesicle. There are hydrophobic function groups, C₁₀˜C₁₈ alkyl chains, at the ends of the side-chain dendrimers. The general formula of the side-chain dendritic random copolymer with various generations is expressed as follows:

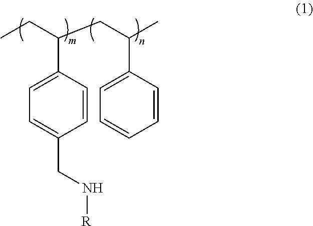

In the general formula, R represents one of various generations of dendrimers such as [G-0.5]-C18, [G-1.5]-C18 and [G-2.5]-C18.

If the dendrimer used in R is intermediate [G-0.5]-C18, the structural formula of an embodiment of the compound expressed in Equation (1) may be given as follows:

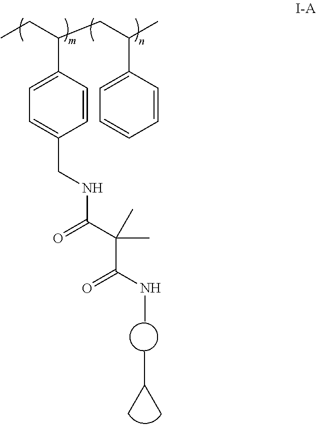

If the dendrimer used in R is the first generation of intermediate [G-1.5]-C18, the structural formula of an embodiment of the compound expressed in Equation (1) may be given as follows:

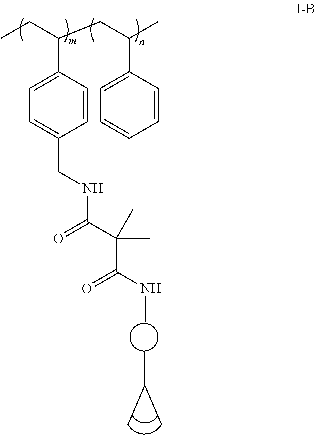

If the dendrimer used in R is the second generation of intermediate [G-2.5]-C18, the structural formula of an embodiment of the compound expressed in Equation (1) may be given as follows:

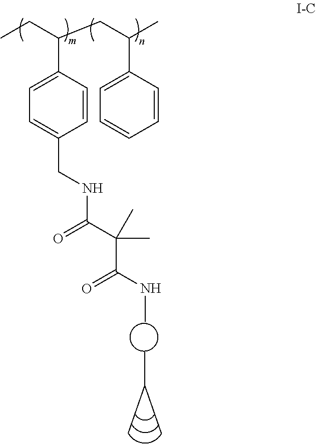

The hydrophobic function group at the end of the dendrimer may be C₁₀H₂₁—, C₁₂H₂₅—, C₁₄H₂₉—, C₁₆H₃₃— or C₁₈H₃₇—.

The process of the present invention will be described through detailed description of several embodiments thereof.

### Embodiment #1

### The Production of a Macromolecular Vesicle

At first, 10 mg of the compound I-A, I-B or I-C is dissolved in 100 ml of chloroform. Then, 5 ml of pH 5.0 phosphoric acid buffer solution is added in the solution in an ice bath. The solution is well blended in a homogenizer operated at 6000 rpm for 4 minutes to provide a first phase of emulsified mixture. The emulsified mixture is rapidly poured into about 100 ml of phosphoric acid buffer solution or de-ionized water. The solution is blended at the room temperature to provide the emulsified solution. The blending lasts for about 5 hours so that all of the organic solvent is vaporized. Finally, the resultant macromolecular vesicle is filtered by 0.2 μm filter paper, and the suspension is concentrated to 5.0 ml.

### Embodiment #2

### The Synthesis of a Dendrimer

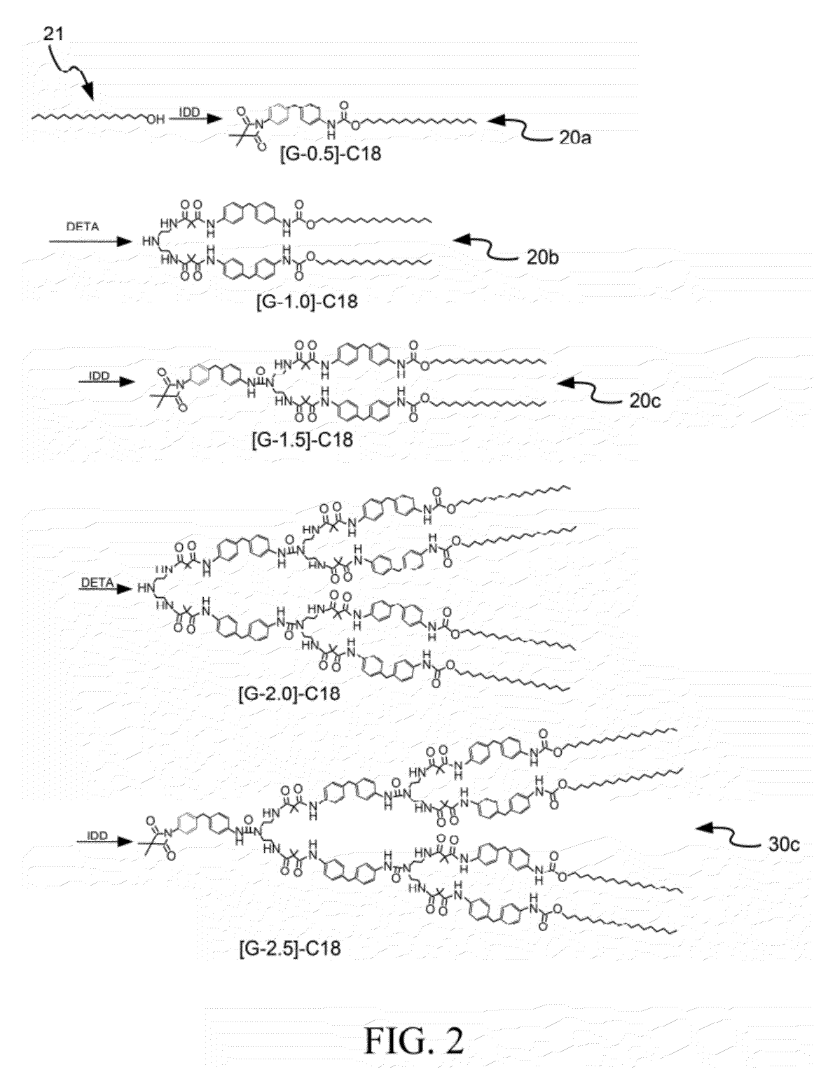

Referring to FIG. 1, there is shown a process for providing an IDD monomer. Referring to FIG. 2, there is shown a process for providing the first generation of dendrimers. At first, a reaction-selective monomer 10 is synthesized. The reaction-selective monomer 10 is preferably IDD (4-isocyanato-4′(3,3-dimethyl-2,4-dioxo-azetidino)diphenylmethane). To this end, methylene diphenyl diisocyanate (“MDI”) reacts with isobutyryl chloride (“IBC”), with triethylamine (“TEA”) used as a reaction reagent.

Then, the IDD 10 and a reagent, diethylenetriamine (“DETA”), are used as building block for reaction with octadecanol 21 based on the reaction selectivity of the IDD 10. A ring-opening reaction occurs between the azetidine-2,4-dione functional group in the IDD 10 and the primary amine of DETA alternately to provide the first, second and third generations of dendrimers as shown in FIG. 2. The method for making dendrimers according to the present invention will be described through detailed description of the process for making the first generation of intermediate.

In a first phase, IDD is dissolved in tetrahydrofuran (“THF”). Octadecanol is added in the solution. Nitrogen is introduced to the solution. Reaction is conducted at 70° C. for 4 hours. After the reaction is completed, methanol is added in the solution for precipitation. The solution is stirred at 70° C. for 6 hours. Air-suction filtering is conducted to collect the product. The product is dried to provide intermediate [G-0.5]-C18 20a.

In a second phase, the [G-0.5]-C18 is dissolved in tetrahydrofuran, and nitrogen is introduced to the solution. The solution is stirred at 70° C. while DETA is slowly added in the solution. After some time of reaction, a first generation of products [G-1]-C18 is precipitated. The reaction lasts for 3 hours before the solution is cooled at the room temperature and washed with a lot of tetrahydrofuran. Air-suction filtering is conducted to provide a first generation of dendrimers [G-1]-C18 20b.

In a third phase, the [G-1]-C18 is dissolved in tetrahydrofuran. Nitrogen is introduced to the solution while the solution is blended at 70° C. After the [G-1]-C18 is completely dissolved, IDD is added in the solution, and reaction is conducted for 4 hours. A portion of the tetrahydrofuran is removed with a rotary evaporator. Methanol is added in the solution for precipitation. Air-suction filtering and drying are conducted to provide a first generation of intermediate [G-1.5]-C18 20c.

The foregoing steps are repeated to provide a second generation of intermediate [G-2.5] 30c and a third generation of intermediate [G-3.5].

### Embodiment #3

### The Synthesis of a Styrene Random Copolymer

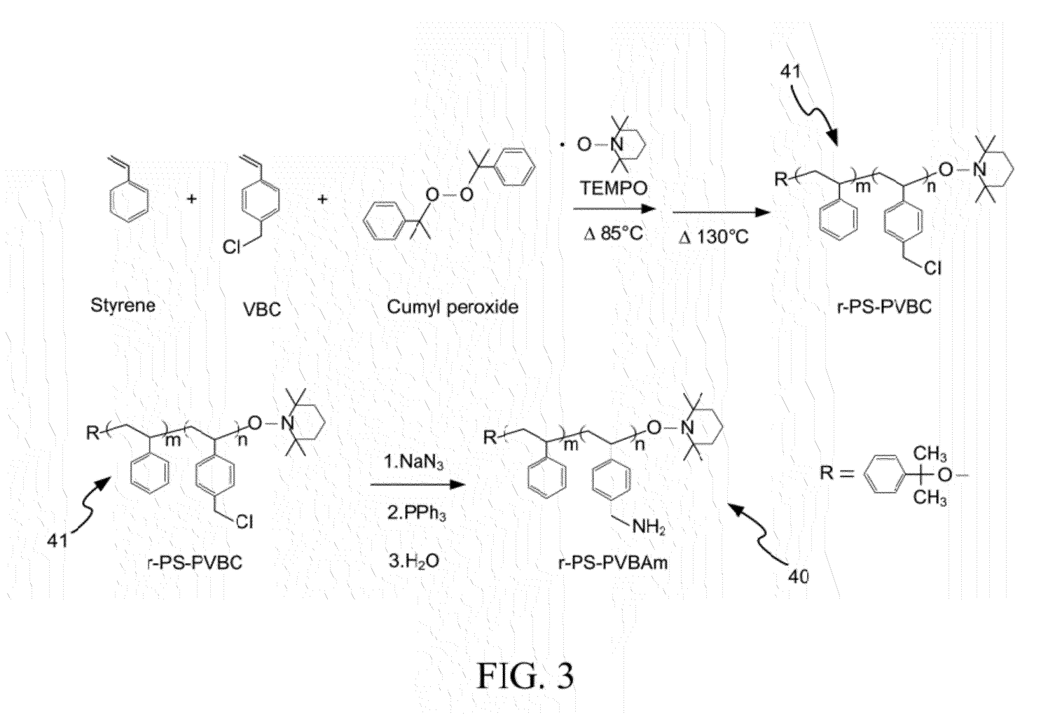

Referring to FIG. 3, there is shown a process for synthesizing a styrene random copolymer according to the present invention. For the synthesis of the random copolymer, primary amine group in the copolymer side-chain reacts with an azetidine-2,4-dione functional group in the IDD to provide a styrene random copolymer with side-chains that grafted dendrimers.

To synthesize the styrene random copolymer, 0.51 grams of cumyl peroxide are dissolved in 15 ml of toluene. Then, 30 ml of styrene and 10 ml of 4-vinylbenzyl chloride (“VBC”) are added in the solution. Then, 0.59 gram of TEMPO (2,2,6,6-tetramethyl-1-piperidinyloxy, free radical) is added in the solution. Nitrogen is introduced to the solution, and reaction is conducted at 85° C. for 1 hour. The temperature is increased to 130° C., and reaction is conducted for 8 hours. The reaction is controlled, and the resultant product is dissolved in tetrahydrofuran. The solution is concentrated before a lot of methanol is added therein. Filtering and vacuum drying are conducted to provide r-PS-PVBC 41 in the form of white powder with a yield of 75%.

Then, 3 grams of the r-PS-PVBC41 are dissolved in 25 ml of tetrahydrofuran. 0.39 gram of sodium azide (“NaN₃”) is added in the solution. 25 ml of dimethyl sulfoxide (“DMSO”) is added in the solution. Nitrogen is introduced to the solution, and reaction is conducted at 60° C. for 48 hours. Then, vacuum distillation is conducted to remove the tetrahydrofuran. A lot of de-ionized water is added in the solution, and ethyl acetate (“EA”) is added in the solution for extraction. The resultant product is subjected to vacuum drying to provide r-PS-PVBAz in the form of yellow solid.

The r-PS-PVBAz is dissolved in tetrahydrofuran. Triphenylphosphine (“PPh₃”) is added in the solution. Nitrogen is introduced to the solution, and reaction is conducted at the room temperature for 2 hours. De-ionized water is added in the solution. Vacuum drying is conducted on the resultant product to provide a styrene random copolymer r-PS-PVBAm 40 with a yield of 85%.

### Embodiment #4

### The Synthesis of the Compound I-A

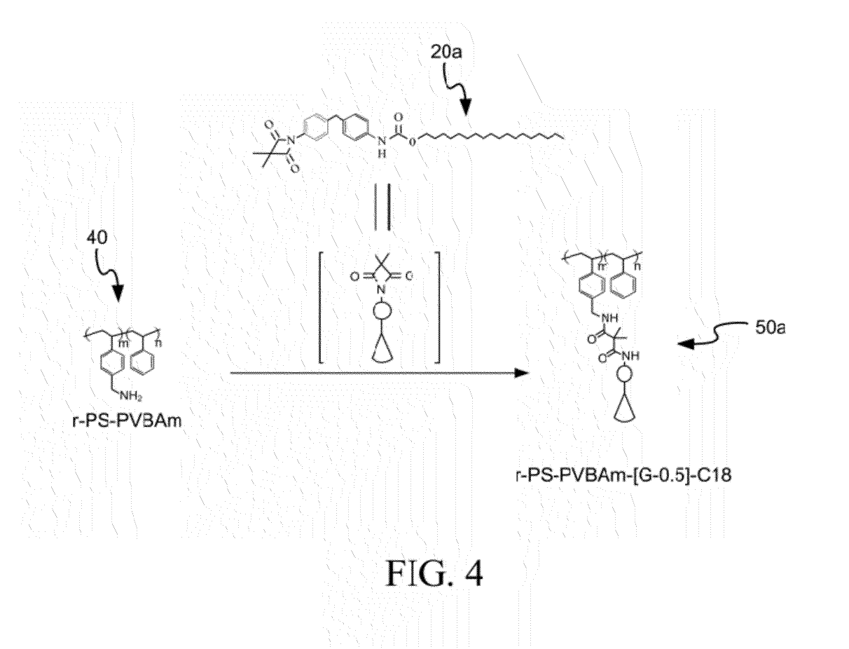

Referring to FIG. 4, there is shown a process for synthesizing r-PS-PVBAm-[G-0.5]-C18. 25 ml of tetrahydrofuran is used as a solvent. 1 gram of styrene random copolymer r-PS-PVBAm 40 is dissolved in the solvent before 1.1 grams of a dendrimer [G-0.5]-C18 20a is added in the solution. At 90° C., nitrogen is introduced to the solution, and reaction is conducted for 24 hours. Column chromatography and vacuum drying are conducted on the resultant product to provide r-PS-PVBAm-[G-0.5]-C18 50a, i.e., the compound I-A in the form of yellow solid with a yield of 57%.

### Embodiment #5

### The Synthesis of the Compound I-B

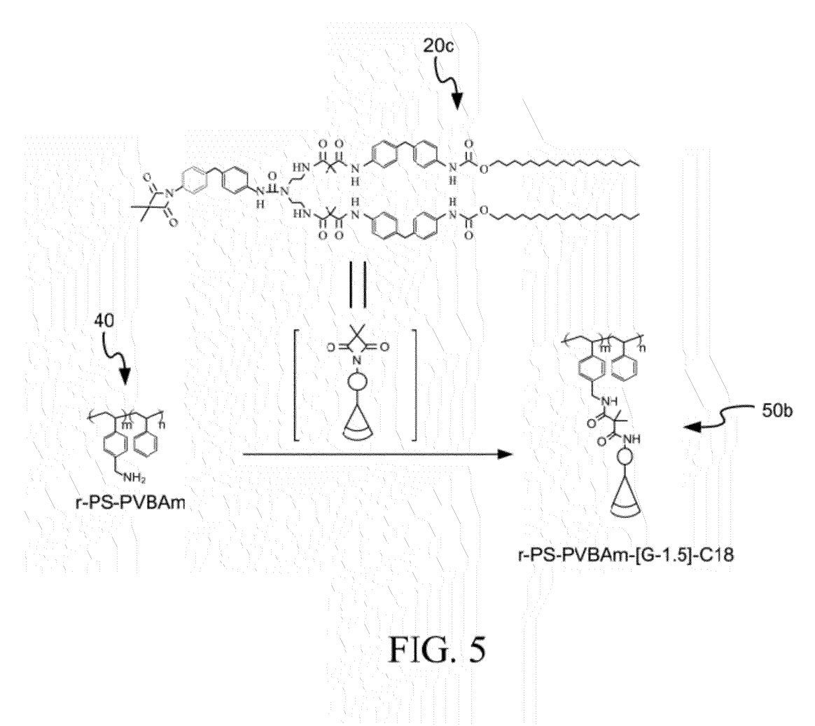

Referring to FIG. 5, there is shown a process for making r-PS-PVBAm-[G-1.5]-C18. 25 ml of tetrahydrofuran is used as a solvent. 1 gram of styrene random copolymer r-PS-PVBAm 40 is dissolved in the solvent before 2.2 grams of the dendrimer [G-1.5]-C18 20c is added. At 90° C., nitrogen is introduced to the solution, and reaction is conducted for 24 hours. Column chromatography and vacuum drying are conducted on the resultant product to provide r-PS-PVBAm-[G-1.5]-C18 50b, i.e., the compound I-B in the form of a light yellow solid with a yield of 47%.

### Embodiment #6

### The Synthesis of the Compound I-C

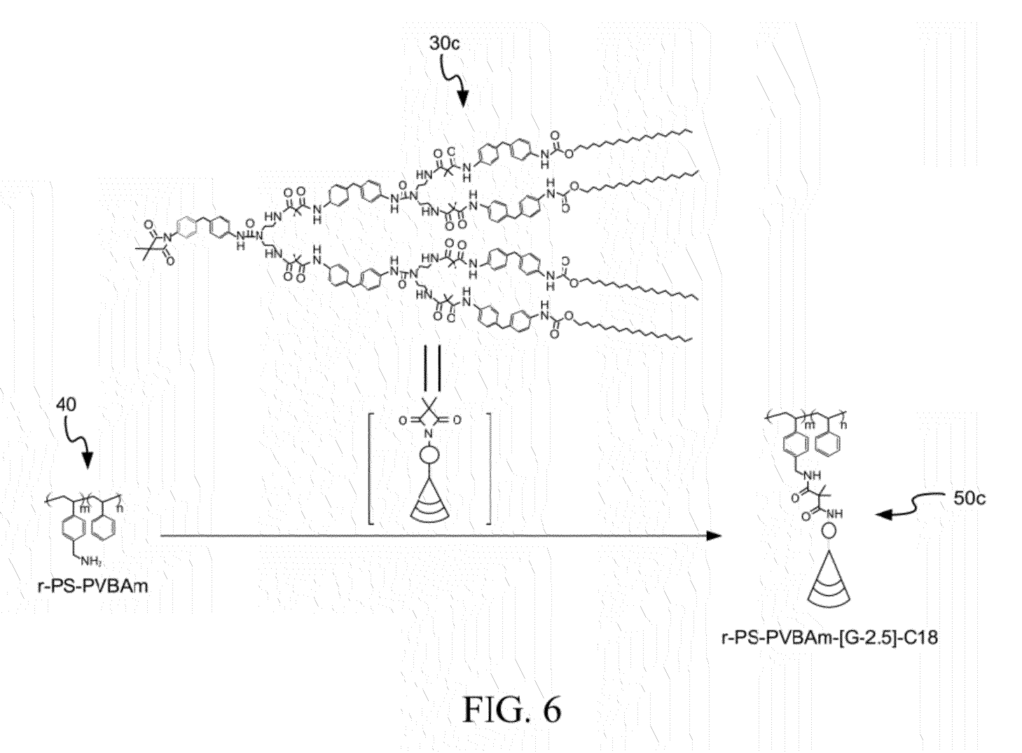

Referring to FIG. 6, there is shown a process for making r-PS-PVBAm-[G-2.5]-C18 according to the present invention. 25 ml of tetrahydrofuran is used as a solvent. 1 gram of styrene random copolymer r-PS-PVBAm 40 is dissolved in the solvent before 4.8 grams of the dendrimer [G-2.5]-C18 20a is added. At 90° C., nitrogen is added, and reaction is conducted for 24 hours. Column chromatography and vacuum drying are conducted on the resultant product to provide r-PS-PVBAm-[G-2.5]-C18 50c, i.e., the compound I-C in the form of yellow solid with a yield of 32%.

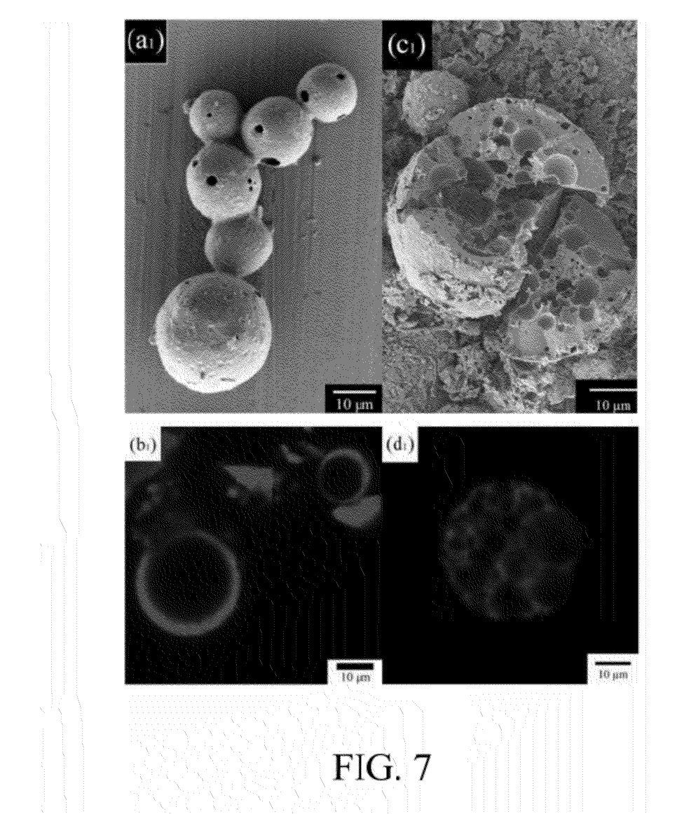

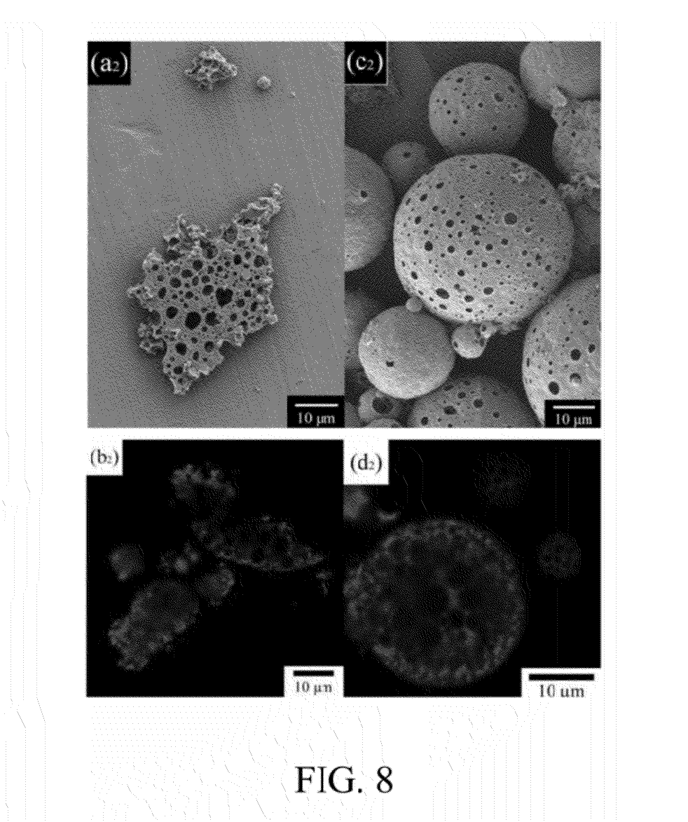

FIG. 7 is a microscopic photograph of the compound I-B. FIG. 8 is a microscopic photograph of the compound I-C. The macromolecular vesicles made in Embodiments #5 and #6 are shown. Upper portions (a₁) and (c₁) of FIG. 7 are photographs of the compound I-B taken by a scanning electron microscope (“SEM”). Lower portions (b₁) and (d₁) are photographs of the compound I-B taken by a confocal laser scanning microscope (“CLSM”). Upper portions (a₂) and (c₂) of FIG. 8 are photographs of the compound I-C taken by a scanning electron microscope. Lower portions (b₂) and (d₂) are photographs of the compound I-C taken by a confocal laser scanning microscope.

As discussed above, the method for making a side-chain dendrimer vesicle according to the present invention overcomes the problems related to the prior art. According to the present invention, dendrimers are grafted to a styrene random copolymer. Two steps of emulsification are taken to induce the side-chain dendritic random copolymer solution self-assembling into the macromolecular vesicle. There are hydrophobic function groups, C₁₀˜C₁₈ alkyl chains at the ends of the side-chain dendrimers.

The present invention has been described via the detailed illustration of the embodiments. Those skilled in the art can derive variations from the embodiments without departing from the scope of the present invention.

Therefore, the embodiments shall not limit the scope of the present invention defined in the claims.

1. A method for making a side-chain dendrimer vesicle including the steps of
providing a random copolymer with a narrow distribution of molecular weights by active polymerization and chemical modification;
executing chemical modification to graft various generations of dendrimers to the random copolymer to provide a side-chain dendritic random copolymer with various generations; and
taking two steps of emulsification to cause macromolecular self-assembling of the side-chain dendritic random copolymer solution to form a macromolecular vesicle, wherein the side-chain dendrimer includes C₁₀˜C₁₈ hydrophobic alkyl chains, wherein the structural formula of the side-chain dendritic random copolymer with various generations is as follows: 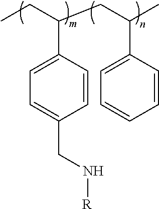
wherein R represents one of the generations of dendrimers including [G-0.5]-C18, [G-1.5]-C18 and [G-2.5]-C18.

2. The method according to claim 1, wherein the hydrophobic function groups of the dendrimers are C₁₀H₂₁—, C₁₂H₂₅—, C₁₄H₂₉—, C₁₆H₃₃— and C₁₈H₃₇—.

3. The method according to claim 1, wherein the dendrimers are synthesized by using 4-isocyanato-4′(3,3-dimethyl-2,4-dioxo-azetidino)diphenylmethane (“IDD”) and diethyleneamine (“DETA”) as building blocks, wherein reaction is executed based on the reaction selectivity of the IDD and alkyl alcohol, wherein a ring-opening reaction occurs through an azetidine-2,4-dione function group of the IDD and primary amine group to eventually provide the first to third generations of dendrimers, wherein the ring-opening reaction includes the steps of:
(A) dissolving the IDD in tetrahydrofuran (“THF”), and adding the alkyl alcohol in the solution, and introducing nitrogen to the solution for reaction, and adding methanol in the solution for precipitation, and stirring and air-suction filtering and drying the solution to provide intermediate [G-0.5]-C18;
(B) dissolving the [G-0.5] in tetrahydrofuran, and introducing nitrogen in the solution, and slowly adding DETA in the solution, and deposing the first generation of product [G-1], and cooling and washing the first generation of product [G-1] with tetrahydrofuran, and air-suction drying the solution to provide the first generation of dendrimer [G-1]-C18;
(C) dissolving the [G-1] in tetrahydrofuran, and introducing nitrogen to the solution for stirring, and adding IDD in the solution after the [G-1] is completely dissolved, and using a rotary evaporator to remove a portion of the tetrahydrofuran, and adding methanol to solution for precipitation, and air-suction filtering and drying the solution to provide the first generation of intermediate [G-1.5]-C18; and
(D) repeating the foregoing steps to provide the second generation of intermediate [G-2.5]-C18 and the third generation of intermediate [G-3.5]-C18.

4. The method according to claim 1, wherein the synthesis of the side-chain dendritic copolymer is based on reaction of primary amine group with the azetidine-2,4-dione function group of the IDD unit, thus providing the styrene random copolymer including side-chains that graft dendrimers, the synthesis including the steps of:
(E) providing cumyl peroxide in toluene, and adding styrene and 4-Vinylbenzyl Chloride (“VBC”) in the solution, and adding 2,2,6,6-tetramethyl-1-piperidinyloxy, free radical (“TEMPO”) in the solution, and introducing nitrogen to the solution for reaction, and concentrating, and filtering and vacuum drying to provide r-PS-PVBC;
(F) dissolving the r-PS-PVBC in tetrahydrofuran, and adding sodium azide (“NaN₃”) and dimethyl sulfoxide (“DMSO”) in the solution, and introducing nitrogen to the solution for reaction, and removing the tetrahydrofuran by vacuum distillation, and adding de-ionized water in the solution, and adding ethyl acetate (“EA”) in the solution for extracting an EA layer, and vacuum drying to provide r-PS-PVBAz; and
(G) dissolving the r-PS-PVBAz in tetrahydrofuran, and adding triphenylphosphine (“PPh₃”) in the solution, and introducing nitrogen to the solution for reaction, and adding de-ionized water in the solution for reaction, and vacuum drying the solution to provide a styrene random copolymer r-PS-PVBAm.

5. The method according to claim 4, wherein the styrene random copolymer r-PS-PVBAm is dissolved before a dendrimer is added in the solution, and nitrogen is introduced to the solution for reaction, and column chromatography and vacuum drying are conducted on the solution to provide a r-PS-PVBAm-R, wherein R represents one of the generations of dendrimers including [G-0.5]-C18, [G-1.5]-C18 and [G-2.5]-C18.

6. The method according to claim 1, wherein the compound with the side-chain dendritic random copolymer with various generations is dissolved in the solution before phosphoric acid buffer solution is added in the solution in a bath, and the solution is well stirred to provide a first phase of emulsified mixture, and the emulsified mixture is added in phosphoric acid buffer solution or de-ionized water and stirred at the room temperature to provide emulsification solution until all of the organic solvents are evaporated, and the resultant macromolecular vesicle suspension is filtered and concentrated.

7. A dendrimer vesicle made in the method according to claim 1.
